(19) United States
(12) Patent Application Publication
(10) Pub. No.: US 2012/0113357 A1
(43) Pub. Date: May 10, 2012

(54) Transmissive Liquid Crystal Display with Reflective Mode

(75) Inventors: Hui-Chuan Cheng, Oviedo, FL (US); Zhibing Ge, Sunnyvale, CA (US); Shin-Tson Wu, Oviedo, FL (US); Wang-Yang Li, Xinhua Town (TW); Chung-Kuang Wei, Taipei City (TW)

(73) Assignees: Chimei InnoLux Corp., Tainan County (TW); University of Central Florida Research Foundation, Inc., Orlando, FL (US)

(21) Appl. No.: 12/940,719

(22) Filed: Nov. 5, 2010

Related U.S. Application Data
(60) Provisional application No. 61/258,665.

(51) Int. Cl. G02F 1/1335

(52) U.S. Cl. 349/64; 349/114; 349/187

(57) ABSTRACT

Method, system and device for a transflective liquid crystal display with both transmissive and reflective functions is realized by using a transflective component into a transmissive LCD. The transflective component can be a transparent substrate with patterned reflectors on one surface and repetitive patterned lenses or prisms formed on the opposite surface facing the backlight unit. The transparent areas substantially allow the optical beams to pass through. The light from the backlight is refracted or focused by the optical structures onto the transparent areas or apertures of other surface, thus a substantial amount of backlight transmits to the LC for light modulation for different gray levels. For the incident ambient light incident on the transflective component, the majority is reflected back to the viewer by the reflectors on the transflective component, and the remainder transmits the transflective component to the backlight unit and be recycled to be used again.

This application claims the benefit of priority to U.S. Provisional Application No. 61/258,665 filed on Nov. 6, 2009.

### FIELD OF THE INVENTION

This invention relates to transflective liquid crystal displays, and, in particular, a transmissive LCD with an internal transflective optical component inside that has both transmissive and reflective functions simultaneously, the component shows high transmission for light incident from one direction, and strong reflection for light coming from the opposite side.

### BACKGROUND AND PRIOR ART

Transmissive liquid crystal display (LCD) is widely used as information display tools, such as cell phone, personal digital assistant, laptop computer and so on. In a transmissive LCD, a liquid crystal layer is sandwiched between two perpendicularly rubbed transparent substrates with Indium-Tin-Oxide (ITO) coatings. Two linear polarizers are placed at the outside of transparent substrates to act as a polarizer and an analyzer whose transmission directions are usually perpendicular to each other. In addition, a backlight is put outside of the polarizer as the light source. But a major drawback of the transmissive LCD is that its backlight source should be on all the time when the display is in use; therefore, the power consumption is relatively high. Another disadvantage is that the image of transmissive LCD is easily washed out under strong ambient light conditions, such as outdoor sunlight.

Reflective LCD, on the other hand, has no built-in backlight source. Instead, it utilizes ambient light for reading the displayed images, where a reflector is formed below the liquid crystal cell. Compared to the transmissive LCD, the reflective LCD has advantages including low power consumption, light weight, and good outdoor readability. However, a reflective LCD relies on ambient light and thus is inapplicable under low light levels or dark ambient conditions.

As a solution for LCDs that needs low power consumption and outdoor readability, a transflective LCD is developed. In a typical transflective LCD, each pixel of the display is divided into two regions: a transmissive region and a reflective one. Thus both transmissive and reflective functions can be obtained from this single device to fuse the advantages of both modes. One example of such a transflective LCD is the dual cell gap design as described in U.S. Pat. No. 6,341,002. A brief plot of one repetitive pixel of the device is shown in FIG. 1a with a transmissive region 10a and a reflective region 10b. The liquid crystal cell 14 is sandwiched between two substrates 11a and 11b, which together are further interposed between two linear polarizers (not shown here). Driving electrodes 12a and 12b are made of transparent conductive material like ITO, and a metal reflector 13 is formed in the reflective part, which also functions the electrode in that area. The cell gap of the liquid crystal layer 14 in the reflective region 10b is about half of that in the transmissive region 10b. Thus light from the backlight 15 functions as the light source for the transmissive part, and light from ambient serves as the light source for the reflective part. However, the fabrication related to such designs using divided transmissive and reflective regions in each pixel is quite complex, thus is only confined to applications in small to medium panels, like a cell phone or GPS.

In another attempt is described in P. L. Chen et al, “Micro Reflection Properties of Transmissive TFT LCD,” IDW'03, pp. 737-740 (2003) as shown in FIG. 1b, the reflective functions are obtained from a transflective film 26, usually using Dual Brightness Enhancement Film (DBEF), of the backlight module in a typical transmissive LCD. In FIG. 1b, a liquid crystal cell 24 formed on two glass substrates 21a and 21b are further sandwiched between a rear linear polarizer 23a and a front linear polarizer 23b. Driving electrodes 22a and 22b are made of ITO as well. A DBEF 26 is placed between the rear linear polarizer 23a and the bottom backlight source 25. This DBEF 26 is typically the stack of multiple dielectric layers that has symmetric or identical transmissive and reflective properties when the light is incident from one side or the other side.

When the light 31a from the backlight module 25 incidents on the DBEF 26 which is placed between the rear linear polarizer 23a and the backlight source 25, there is transmittance light 31b toward the viewer 40 and reflection light 31c back to the backlight module. Similarly, for the incident ambient light 30a, the reflection light 30c will go to the viewer side 40, and the transmission part 30b will go to the backlight source. Under the strong ambient light, the reflective light 30c from the DBEF 26 is strong and increase the brightness of the LCD. Therefore, the viewer 40 gets better contrast ratio and legibility of the panel. Usually, for different applications, the transmission and reflection ratio of the transflective film 26 can be tuned from 2:8 to 8:2. Usually, to get a sufficient reflectance of this device, the ratio of reflection is large.

This configuration to achieve the transflective functions is much simpler as compared to the designs using divided transmissive and reflective regions in each pixel as FIG. 1a. However, the light loss from this transflective film 26 reduces the light efficiency of backlight module 25. As shown in FIG. 1b, for the incident light 31a, part of the light 31c is reflected back to the light source and is recycled in the backlight module 25. However, the light 31c during recycling experiences a big loss. Thus, adding a transflective film sacrifices the backlight efficiency to obtain certain reflective function. As the transmissive mode is more frequently used for mobile displays or public advertisement displays, a sacrifice of the backlight efficiency is a problem.

There is need for a new transflective component that has high transmission for the backlight, and has high reflection for the ambient light to solve the above problems. This special transflective component does not obey the symmetric or identical transmissive and reflective properties for the light incident in opposite directions which means it has high transmission and low reflection for light incident from one preferred direction, but for the other direction, the component is with the properties of low transmission and high reflection. By replacing the DBEF 26 with this special transflective component, the brightness of the transmissive LCD will increase because of using the reflection from the ambient light as the light source and does not lose the light from the backlight. Such a special transflective component will have great applications in displays that require reflective function to obtain sunlight readability.

### SUMMARY OF THE INVENTION

A first objective of the invention is to design a new transflective LCD that comprises a transmissive LCD and a transflective component.

A second objective of this invention is to provide a new optical transflective component in the transmissive LCD abovementioned in the first objective that could show high transmission (and weak reflection) for the light incident from one direction, and high reflection for the light coming from the opposite direction simultaneously.

A third objective of this invention is to achieve good image quality of LCD by using its transmissive mode with the backlight as the first light source, and achieving good outdoor image readability by using the reflective mode with the ambient light as the second light source.

A first embodiment provides a transflective liquid crystal display device having both transmissive and reflective functions including a backlight module, a first transparent glass substrate and a second transparent glass substrate, the second glass substrate being positioned closer to a backlight module than the first glass substrate with a liquid crystal cell with a plurality of pixels formed between the inner surfaces of the first and second glass substrates. A first linear polarizer and a second linear polarizer, the second linear polarizer being positioned closer to the backlight module than the first linear polarizer are formed in the first and second substrates, respectively. The LCD also includes a transflective component placed between the second linear polarizer and the backlight module, made of a transparent plate having a first surface facing the second linear polarizer and an opposing second surface facing the backlight module, wherein the first surface has a plurality of patterned reflective structures that can partially reflect the incident light from the ambient, and the second surface has a plurality of optical structures that can substantially transmit the light incident from the backlight module. The light from the backlight module can substantially transmit the transflective component to the liquid crystal cell as a first light source; and the ambient light passing to the transflective component can be partially reflected by the patterned structures and be re-directed back to the liquid crystal cell as a second light source.

The reflective structures on the transflective component includes a reflective layer with etched apertures made of one of a thin metal layer selected from aluminum or silver, or a dielectric multi-layer reflector, or a layer with high reflectivity material, wherein the reflective region has a bumpy shaped surface. The apertures on the first surface of the transflective component are a plurality of circles and the circled aperture has a radius between approximately 1 μm and approximately 20 μm and a distance between two adjoining transparent circle centers is between approximately 2 μm and approximately 40 μm. Alternatively, the apertures on the first surface can be a plurality of stripes and the striped aperture can have a width between approximately 1 μm and approximately 20 μm; and a distance between two adjoining transparent stripes is between approximately 2 μm and approximately 40 μn. The optical structures on the second surface facing the backlight module can be a plurality of prisms or lens and the optical structures are aligned in a way that the incident backlight can be deflected onto the transparent apertures of the first surface. The patterned lenses on the second surface can have a diameter between approximately 2 μm and approximately 40 μm and the patterned prisms on the second surface can have a pitch between approximately 2 μm and approximately 40 μm.

A second embodiment provides a method of forming a transflective liquid crystal display device having both transmissive and reflective regions. The display is formed by providing a backlight module, providing a first transparent glass substrate and a second transparent glass substrate, the second glass substrate being positioned closer to a backlight module than the first glass substrate and sandwiching a liquid crystal cell between the inner surfaces of the first and second glass substrates forming with a plurality of pixels. The next step includes layering a first linear polarizer and a second linear polarizer on the first and second transparent substrate, respectively, the second linear polarizer being positioned closer to the backlight module than the first linear polarizer and placing a transflective component between the second linear polarizer and the backlight module, the transflective component made of a transparent plate having a first surface facing the second linear polarizer and an opposing second surface facing the backlight module, wherein the first surface has a plurality of patterned reflective structures that can partially reflect the incident light from the ambient and the second surface has a plurality of optical structures that can substantially transmit the light incident from the backlight module. The light from the backlight module can substantially transmit the transflective component to the liquid crystal cell as a first light source; and the ambient light passing to the transflective component can be partially reflected by the patterned structures and be re-directed back to the liquid crystal cell as a second light source.

Further objects and advantages of this invention will be apparent from the following detailed description of preferred embodiments that are illustrated schematically in the accompanying drawings.

### BRIEF DESCRIPTION OF THE FIGURES

FIG. 1a is a schematic structure of a prior art transflective LCD.

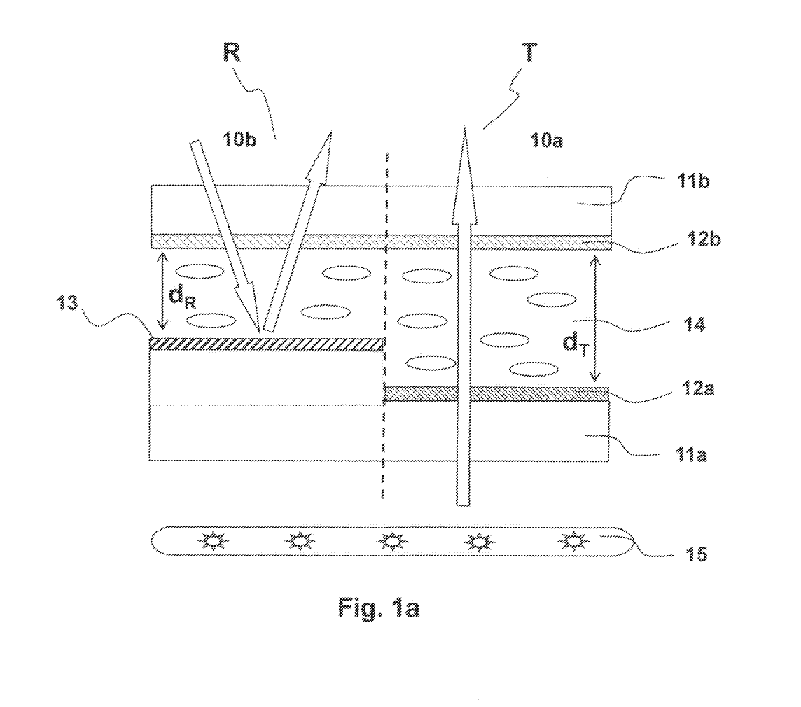

FIG. 1b is a schematic structure of another prior art transflective LCD.

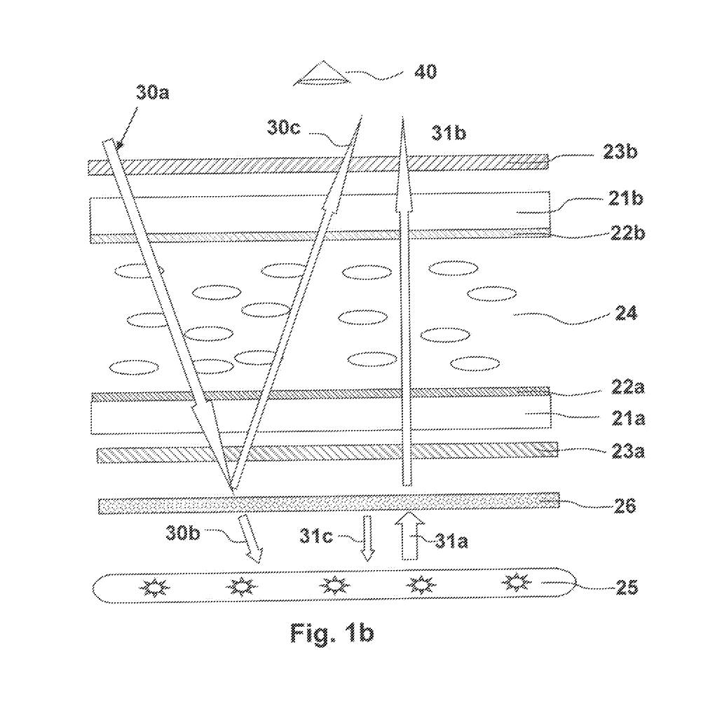

FIG. 2 is a schematic structure showing one example of the new transflective LCD embodiment incorporating a transmissive LCD and a transflective component.

FIG. 3a is a schematic structure showing a cross section of the transflective component in this invention according to the first embodiment.

FIG. 3b is a schematic structure showing a top view of the transflective component.

FIG. 3c is a schematic structure showing a bottom view of the transflective component.

FIG. 4a is a diagram showing the optical ray tracing simulation for the normal incidence.

FIG. 4b is a diagram showing the optical ray tracing simulation for the oblique incidence.

FIG. 5a is a schematic structure showing a cross section of the transflective component in this invention according to the second embodiment.

FIG. 5b is a schematic structure showing a top view of the transflective component in the second embodiment.

FIG. 5c is a schematic structure showing a bottom view of the transflective component.

FIG. 5d is a schematic structure showing a perspective view of the transflective component.

### DESCRIPTION OF THE PREFERRED EMBODIMENTS

Before explaining the disclosed embodiments of the present invention in detail it is to be understood that the invention is not limited in its application to the details of the particular arrangements shown since the invention is capable of other embodiments. Also, the terminology used herein is for the purpose of description and not of limitation.

In the apparatus, method, system and device of the present invention, the transmissive LCD with reflection mode comprises a liquid crystal cell with repetitive pixels formed between two glass substrates, a backlight unit, a first linear polarizer placed close to the front viewer side, a second linear polarizer placed close to the rear backlight unit. The repetitive thin-film-transistors (TFTs) and driving electrodes are formed in the inner surface of the liquid crystal cell on at least one of the glass substrates, and liquid crystal cell is sandwiched between two glass substrates are further interposed between two linear polarizers, and a transflective component that is placed between the backlight unit and the second rear linear polarizer.

The transflective component includes a transparent substrate with two opposite surface, the patterned reflectors formed on the first surface that is close to the second linear polarizer and repetitive patterned lenses or prisms formed on the second surface facing the backlight unit. The transparent areas on the transflective component surface facing the second linear polarizer substantially allows the optical beams to pass through. In the present invention, the voltages coming from the TFTs passes to each pixel to achieve different brightness level, or gray levels. The light from the backlight is refracted or focused by the optical structures of the second surface onto the transparent areas or apertures of first surface of the transflective component, thus a substantial amount of backlight transmits to the liquid crystal cell for light modulation to achieve different gray levels. For the incident ambient light incident on the transflective component, the majority is reflected back to the viewer by the reflectors on the transflective component, and the remainder of the light transmits the transflective component to the backlight unit and is recycled to be used again. Thus, this transmissive display can maintain the high light efficiency of the backlight light and obtain substantial reflectance of the ambient light to enhance the LCD brightness, which is highly preferred for the sunlight readable applications.

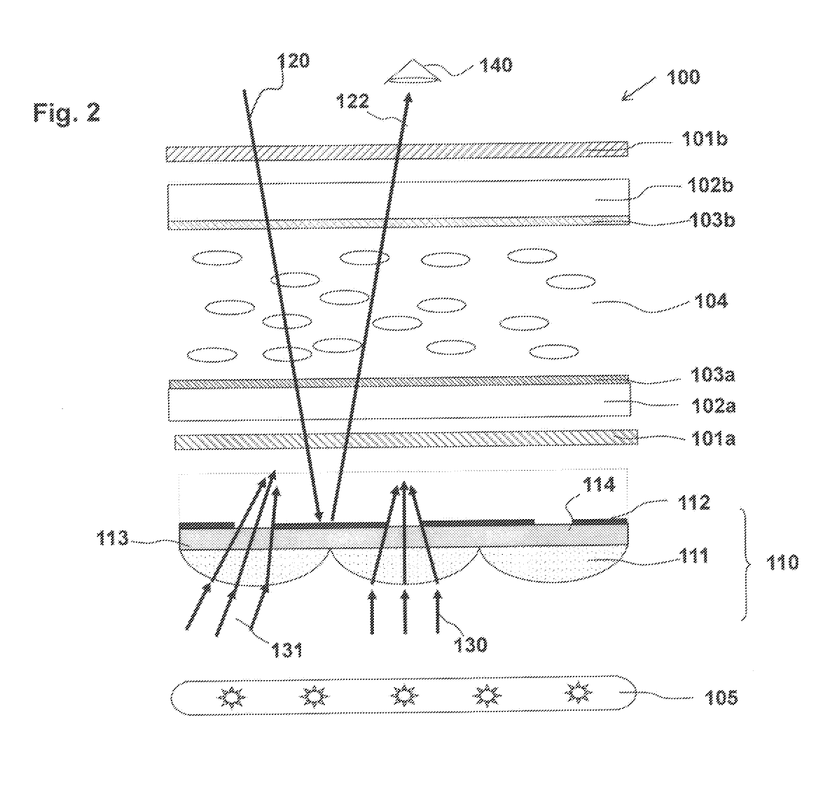

FIG. 2 shows the structure of a first embodiment of the transmissive LCD 100 with a transflective component that has very high transmission (and low reflection) for the backlight 130 and substantial reflection for the ambient light 120. The present invention includes a first transparent substrate 102a with a first alignment layer 103a, and a second transparent substrate 102b with a second alignment layer 103b. A nematic liquid crystal layer 104 is sandwiched between the first alignment film 103a and the second alignment film 103b. A backlight unit 105, a first linear polarizer 101a between the second substrate 102b and the backlight unit 105, a second linear polarizer 101b between the viewer 140 and the first substrate 102a, and a transflective component 110 that is placed between the backlight unit 105 and the rear linear polarizer 101a.

The transflective component 110 can be a transparent substrate 113 with repetitive patterned lenses 111 formed on the substrate surface facing the backlight unit 105 and repetitive patterned reflectors 112 with apertures 114 on the other substrate surface facing the rear linear polarizer 101a. For the normally incident light 130 from the backlight module 105, the lens array 111 focuses and refracts the incident light 130 onto the corresponding apertures 114 and all the incident light 130 passes through the transflective component 110. For the oblique incident light 113, with the proper design of the thickness of the substrate 113, the focal length of the lens array 111 and the dimension of the opining 114, the substantial portion of the off-axis incident light 131 is focused and refracts into the apertures 114. On the other hand, the incident ambient lights 120 impinging on the reflectors 112 is reflected back to the liquid crystal cell 104 and further to the viewer 140. Because the reflective area 112 is much larger than the opening area 114, most of the ambient light 120 is reflected.

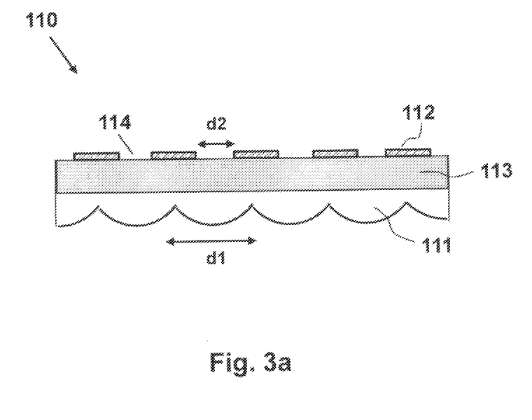

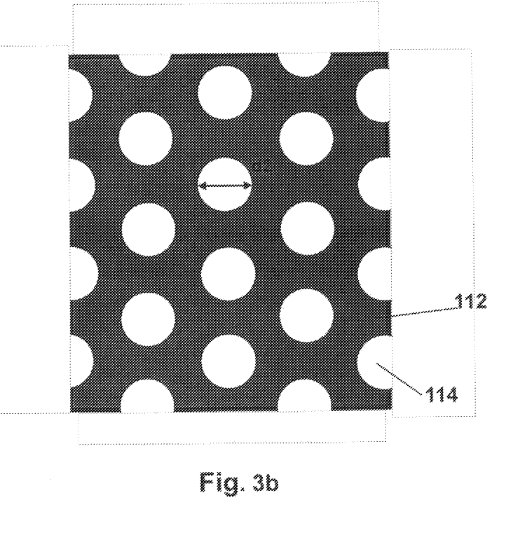

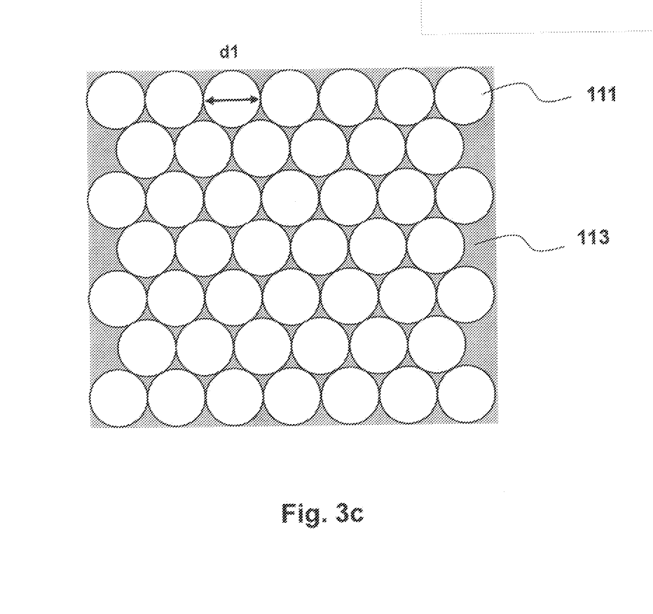

FIG. 3a shows the detailed plot of the transflective component 110. Typically, the dimension of the lens diameter d1 should be smaller than the pixel dimension of LCD. The shape of the lens could be spherical or non-spherical type. The apertures dimension d2 is determined by the beam waist of the lens array 111. Typically, d1 is from approximately 2 μm to approximately 40 μm, and d2 is from approximately 1 μm to approximately 20 μm. For the highly collimated light, the beam waist is smallest and the apertures dimension d2 is the size of the beam waist to let the light pass through. The smaller apertures dimension means the larger reflective area 112, and the reflection of this component for ambient light would become larger, hence increase the brightness of the LCD.

To achieve highly collimated backlight, the prism films can be put between the backlight unit and the transflective component to collimate the light from backlight before entering into the transflective component. FIG. 3b shows the top view of the transflective component, where a substantial area of the surface is occupied by the reflective structure 112. The plurality of apertures 114 let the light coming from the backlight pass through. Because the lenses 111 refract the light from backlight into the apertures 114, the effective transparent area for this component is almost 100% and most light from backlight passes through this special transflective component 110. The reflective area 112 is made of one of a thin metal layer like aluminum or silver, or a dielectric multi-layer reflector, or a layer with high reflectivity material like Barium sulfate. There can be bumpy structures on the surface of the reflective area 112 to scatter the ambient light 120. FIG. 3c is the bottom view of the transflective component 110. The lenses arrangement prefers to be hexagonal type that can have the highest density of the lenses on a restricted area.

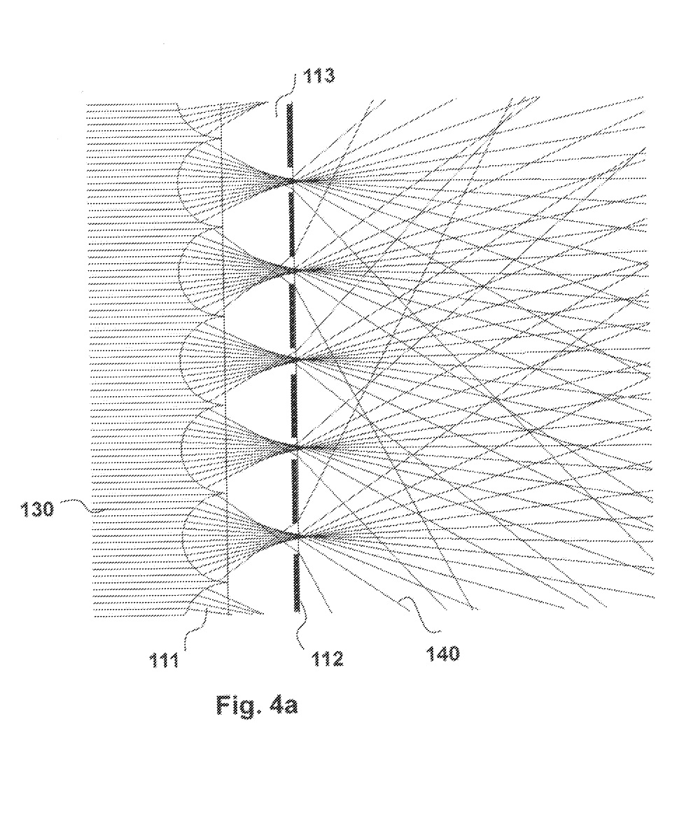

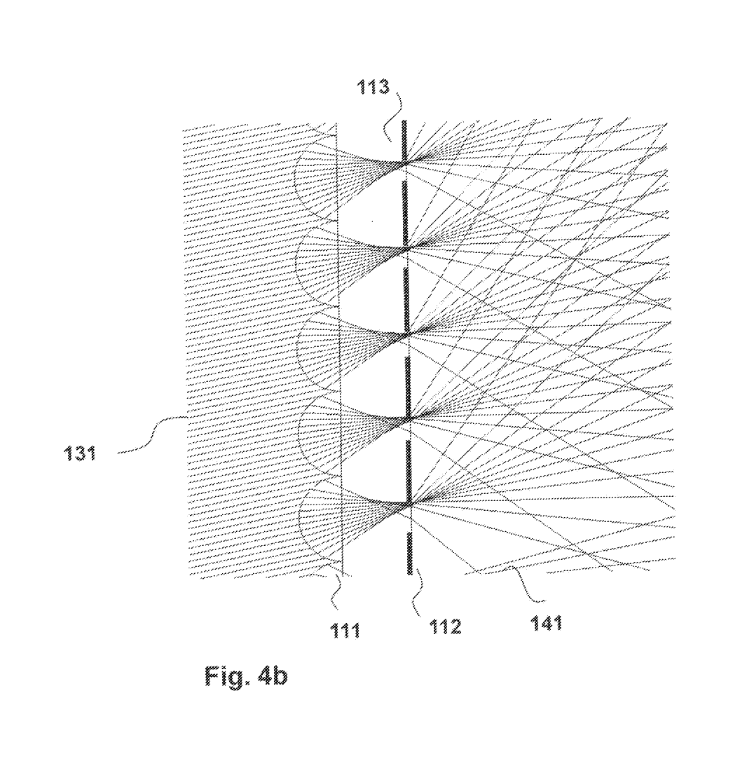

FIG. 4a shows the optical ray tracing simulation of the light transmission and propagation for the backlight incident from the lens side at a normal incidence. For the normally incident lights 130 coming from the backlight side, the lenses 111 on the transflective component 110 will reduce their effective optical beam waist and guide the rays with the reduced waist to pass the apertures 114 on the other surface. Therefore, most of the light from the backlight passes through the transflective component 110 and not blocked by the reflective structure 112. When the lights 140 come out of the transflective component 110, the light will diverge and propagate to the liquid crystal cell thereafter for image display. Because of the large divergence angle of the output light 140, this transflective component also has the diffusion function and works as a diffuser. FIG. 4b shows the same light propagation pattern plot with light coming in at an oblique angle. Similarly, the incident light 131 from backlight side will have most of its light pass the transflective component 110 and be diverged as light 141 to further illuminate the liquid crystal cell. In the real application, the incident light from the backlight is with a variety of incident angles. Although some part of the light 131 with large incident angle might be blocked by the reflector 112, the most parts of the incident light from the backlight still pass through the transflective component.

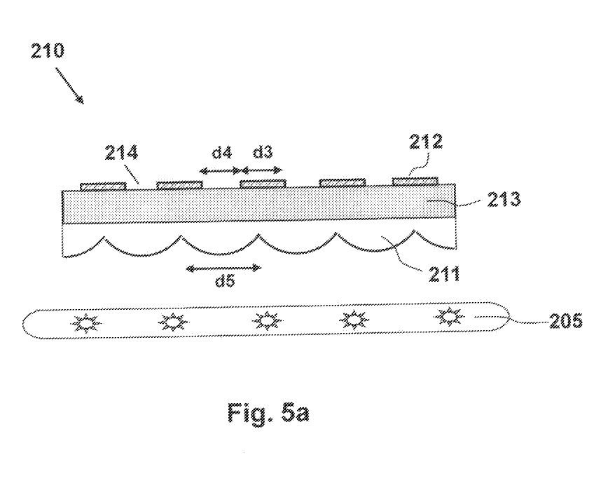

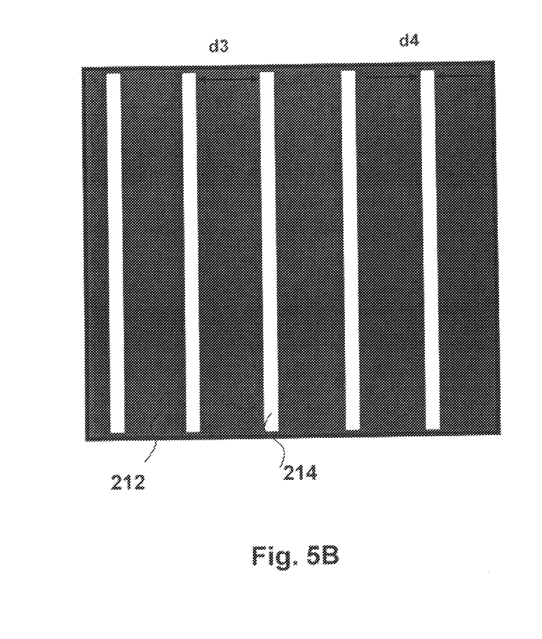

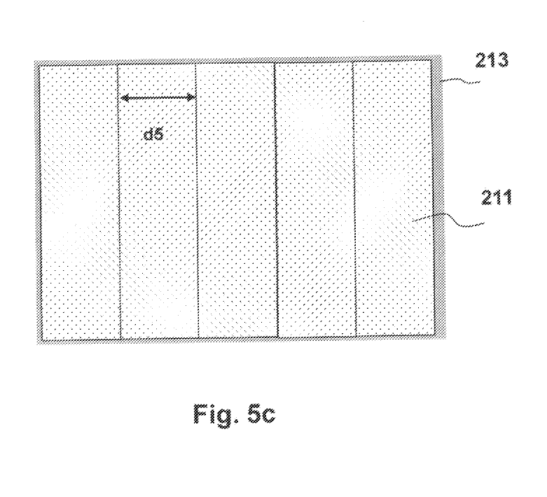

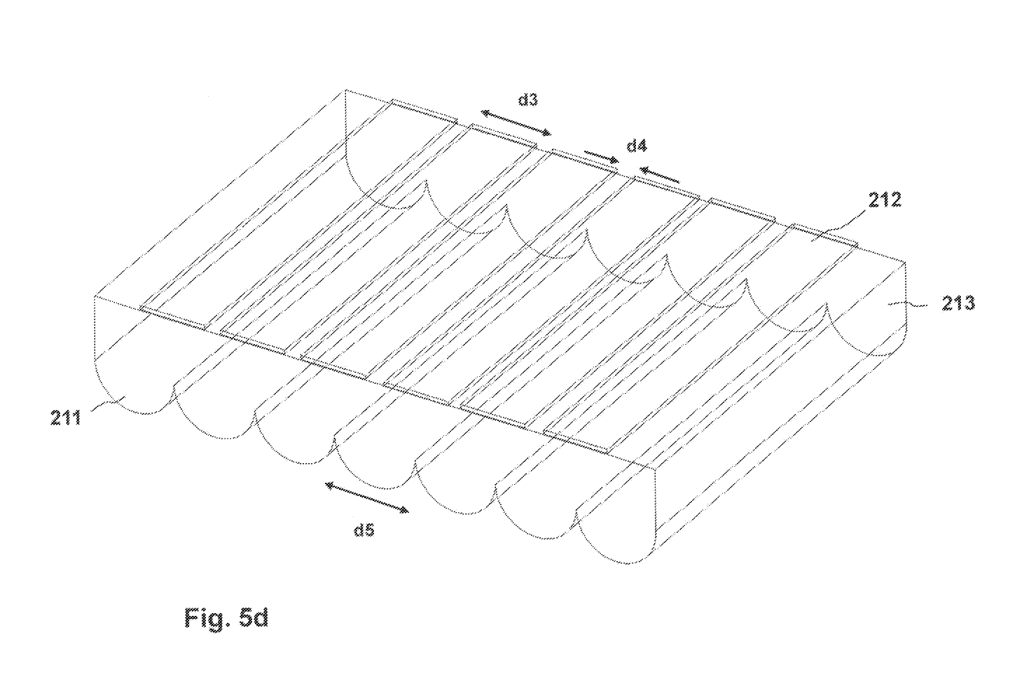

FIG. 5a shows a second embodiment of the present invention. The transflective component 210 includes a transparent substrate 213, repetitive patterned lenses 211 on the surface facing the backlight, and repetitive patterned reflectors 212 with apertures 214 on the other substrate surface. The reflective area 212 can reflect the ambient light to the viewer side and the light from the backlight side can pass the apertures 214 after the backlight refracted by the lens array 211. The shape of the lens array 211 is cylindrical type, and the corresponding apertures 214 are parallel stripes.

FIG. 5b shows the top view of this transflective component, wherein the reflective structures 212 with the width of d3 occupy the substantial area of the surface. The plurality of apertures 214 with the width of d4 let the light from the backlight pass through. Because the cylindrical lens array 211 can refract the light from backlight into the apertures 214, the effective transparent area for this component is almost 100% and most light from backlight will pass through this transflective component 210. The reflective area 212 is covered by the reflective materials. There could be some bumpy structures on the surface of the reflective area 212. FIG. 5c is the bottom view of the transflective component 210. The width of the reflective area d3, the width of the stripe aperture d4, and the diameter of the cylindrical lens d5 are smaller than the dimension of the LCD pixels. Typically, d5 is from approximately 2 μm to approximately 40 μm, and d4 is from 1 μm to 20 μm. FIG. 5d is the perspective view of the design.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A transflective liquid crystal display device having both transmissive and reflective functions comprising:
a backlight module;
a first transparent glass substrate;
a second transparent glass substrate, the second glass substrate being positioned closer to a backlight module than the first glass substrate;
a liquid crystal cell formed between the inner surfaces of the first and second glass substrates forming a plurality of pixels;
a first linear polarizer;
a second linear polarizer, the second linear polarizer being positioned closer to the backlight module than the first linear polarizer;
a transflective component placed between the second linear polarizer and the backlight module made of a transparent plate having a first surface facing the second linear polarizer and an opposing second surface facing the backlight module, wherein the first surface has a plurality of patterned reflective structures that partially reflect the incident light from the ambient and the second surface has a plurality of protruding optical structures that substantially transmit the light incident from the backlight module; and
wherein the light from the backlight module can substantially transmit the transflective component to the liquid crystal cell as a first light source; and the ambient light passing to the transflective component can be partially reflected by the patterned structures and be re-directed back to the liquid crystal cell as a second light source.

2. A transflective liquid crystal display device of claim 1, wherein the reflective structures on the transflective component comprises:
a reflective layer with etched apertures made of one of a thin metal layer selected from aluminum or silver, or a dielectric multi-layer reflector, or a layer with high reflectivity material.

3. A transflective liquid crystal display device of claim 2, wherein the apertures on the first surface of the transflective component are a plurality of circles.

4. A transflective liquid crystal display device of claim 3, wherein the circled aperture has a radius between approximately 1 μm and approximately 20 μm; and a distance between two adjoining transparent circle centers is between approximately 2 μm and approximately 40 μm.

5. A transflective liquid crystal display device of claim 2, wherein the apertures on the first surface is a plurality of stripes.

6. A transflective liquid crystal display device of claim 5, wherein the striped aperture has a width between approximately 1 μm and approximately 20 μm and a distance between two adjoining transparent stripes is between approximately 2 μm and approximately 40 μm.

7. A transflective liquid crystal display device of claim 1, wherein the optical structures on the second surface facing the backlight module is a plurality of prisms or lens.

8. A transflective liquid crystal display device of claim 7, wherein the optical structures are aligned so the incident backlight is deflected onto the transparent apertures of the first surface.

9. A transflective liquid crystal display device of claim 7, wherein the patterned lenses on the second surface has a diameter between approximately 2 μm and approximately 40 μm.

10. A transflective liquid crystal display device of claim 7, wherein the patterned prisms on the second surface has a pitch between 2 μm and 40 μm.

11. A transflective liquid crystal display device of claim 1, wherein the liquid crystal cell is a transmissive typed liquid crystal display.

12. A method of forming a transflective liquid crystal display device having both transmissive and reflective regions comprising:
providing a backlight module;
providing a first transparent glass substrate and a second transparent glass substrate, the second glass substrate being positioned closer to a backlight module than the first glass substrate;
sandwiching a liquid crystal cell between the inner surfaces of the first and second glass substrates forming with a plurality of pixels;
layering a first linear polarizer and a second linear polarizer on the external side of the first and second transparent substrate, respectively, the second linear polarizer being positioned closer to the backlight module than the first linear polarizer;
positioning a transflective component between the second linear polarizer and the backlight module, the transflective component made of a transparent plate having a first surface facing the second linear polarizer and an opposing second surface facing the backlight module, wherein the first surface has a plurality of patterned reflective structures that partially reflect the incident light from the ambient and the second surface has a plurality of optical structures that substantially transmit the light incident from the backlight module; and
wherein the light from the backlight module can substantially transmit the transflective component to the liquid crystal cell as a first light source; and the ambient light passing to the transflective component can be partially reflected by the patterned structures and be re-directed back to the liquid crystal cell as a second light source.

13. The method of claim 12, further comprising the step of:
forming a reflective layer with etched apertures made of one of a thin metal layer selected from aluminum or silver, or a dielectric multi-layer reflector or a layer with high reflectivity material on one surface of the transflective component.

14. The method of claim 13, wherein the apertures on the first surface of the transflective component are a plurality of circles.

15. The method of claim 14, wherein the circled aperture has a radius between approximately 1 μm and approximately 20 μm and a distance between two adjoining transparent circle centers is between approximately 2 μm and approximately 40 μm.

16. The method of claim 13, wherein the apertures on the first surface is a plurality of stripes.

17. The method of claim 12, further comprising the step of:
forming optical structures on the second surface of the transflective component facing the backlight module.

18. The method of claim 17 wherein the optical structures are formed as a plurality of prisms or lens.

19. The method of claim 17, further comprising the step of aligning the optical structures so the incident backlight is deflected onto the transparent apertures of the first surface.

20. A transflective component comprising:
a substrate having a first and a second surface;
a repetitive pattern of reflectors with apertures on one surface of the substrate; and
a repetitive pattern of optical prisms or lenses on the opposite surface of the substrate.
